(19) United States
(12) Patent Application Publication
(10) Pub. No.: US 2004/0061394 A1
(43) Pub. Date: Apr. 1, 2004

(54) Hydrodynamic bearing, rotor device, and motor

(76) Inventors: Hiromitsu Gotoh, Chiba-shi (JP); Atsushi Ohta, Chiba-shi (JP); Kazuaki Oguchi, Chiba-shi (JP); Shinji Kinoshita, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/639,012

(22) Filed: Aug. 12, 2003

(30) Foreign Application Priority Data
Aug. 29, 2002 (JP) 2002-250008

(51) Int. Cl. H02K 5/16; F16C 32/06

(52) U.S. Cl. 310/90; 384/107

(57) ABSTRACT

A hydrodynamic bearing fitted with a seal portion capable of suppressing oil leakage efficiently is offered. Also, a rotor device and a motor using this bearing are offered. The seal portion is formed using a shaft-side tapering portion formed in a shaft and a sleeve-side tapering portion formed in an insertion hole in a sleeve. If the axis of rotation tilts when the shaft is at rest or during rotation, the interval between the outer surface of the shaft and the inner surface of the insertion hole decreases in the opening portion of the insertion hole. However, the two tapering portions secure a gap sufficient to hold oil within the hydrodynamic bearing if the interval decreases. Leakage of the oil from the opening portion of the insertion hole can be suppressed efficiently.

### BACKGROUND OF THE INVENTION

The present invention relates to a hydrodynamic bearing, rotor device, and motor used, for example, to rotationally drive a magnetic storage medium.

In recent years, hydrodynamic bearings that hold shafts by hydrodynamic pressure produced by oil held inside the bearings have become to be used.

A small-sized motor for driving a hard disk, for example, is available as a commercial product using such a hydrodynamic bearing.

The use of the hydrodynamic bearing makes it possible to obtain a bearing portion that has good rotational characteristics and high shock resistance.

When an impact is applied to a bearing using ball bearings, the balls may be damaged. As a result, normal operation may be hindered. However, in a hydrodynamic bearing, a rotor is held by fluid such as oil and so if an impact is applied, the fluid absorbs the impact. Consequently, the possibility that the bearing portion is damaged is low.

In a case where a hydrodynamic bearing is used, it is an important subject to prevent oil leakage from the hydrodynamic bearing.

FIG. 7 is a view showing one example of the structure of a motor 101 using the prior art hydrodynamic bearing.

The motor 101 has a rotor 103 received in a sleeve 110 having a hollow portion. A shaft 104 is mounted to the rotor 103. A hub 105 fitted with a permanent magnet 108 on its inner surface is mounted to the shaft 104.

Oil is filled among the sleeve 110, rotor 103, and shaft 104. Coils 107 are disposed on the inner surface of the permanent magnet 108 and made to produce a rotating magnetic field. The permanent magnet 108 is attracted by this rotating magnetic field. Thus, the hub 105, shaft 104, and rotor 103 rotate.

Radial hydrodynamic pressure-producing grooves are formed in the shaft 104 and in the sleeve 110. Thrust hydrodynamic pressure-producing grooves are formed in the top and bottom surfaces of the rotor 103. When the shaft 104 and rotor 103 rotate, these grooves carry the oil. Radial hydrodynamic pressure is produced by the radial hydrodynamic pressure-producing grooves. Thrust hydrodynamic pressure is produced by the thrust hydrodynamic pressure-producing grooves.

The hub 105, shaft 104, and rotor 103 are rotatably held by the balance between these hydrodynamic pressures.

In the motor 101 constructed in this way, a tapering portion 106 is formed in the opening portion of the sleeve 110. The inside diameter of this tapering portion 106 increases in going toward the outside from the hollow portion (oil filled side).

Therefore, pressure directed from the outside of the hollow portion toward the inside acts on the oil that is present close to the opening portion of the sleeve 110 by capillarity. Consequently, leakage of the oil can be prevented.

This method of sealing oil is effective where the shaft 104 is on the axis of rotation and the clearance between the shaft 104 and sleeve 110 is constant. However, the shaft 104 is normally tilted from the axis both at rest and during rotation. At this time, the oil swells upward like an oil surface 111 shown in FIG. 8 by surface tension in the narrowed clearance between the shaft 104 and sleeve 110 when the shaft 104 tilts. Therefore, there is the problem that the swollen portion of the oil easily leaks.

### SUMMARY OF THE INVENTION

Accordingly, it is an object of the present invention to provide a hydrodynamic bearing fitted with a seal portion capable of effectively preventing oil leakage, as well as a motor using this hydrodynamic bearing.

To achieve the above-described object, the present invention provides a hydrodynamic bearing having (1) a hollow member having a hollow portion provided with at least one opening portion at least one end thereof, (2) a rotating member disposed in the hollow portion so as to be rotatable relative to the hollow member and having a shaft portion extending through the opening portion, (3) fluid interposed between the hollow portion and the rotating member, (4) hydrodynamic pressure-producing means acting on the fluid between the hollow member and a surface of the rotating member that is opposite to the hollow member and producing hydrodynamic pressure with this opposite surface, and (5) a seal portion for preventing leakage of the fluid from the opening portion. The seal portion is formed by an inner diameter-varying portion and an outside diameter-varying portion. The inner diameter-varying portion is so formed that the inside diameter of the opening portion increases in going outward in the axial direction of the shaft portion. The outside diameter-varying portion is so formed that at least a part of the outside diameter of the shaft portion opposite to the inner diameter-varying portion decreases in going outward in the axial direction of the shaft portion (first structure).

The first structure can be so constructed that at least one of the inside diameter of the opening portion and the outside diameter of the shaft portion varies at a constant gradient in the seal portion (second structure).

The first or second structure can be so constructed that the outside diameter of the shaft portion varies at a constant gradient in the seal portion and that where the maximum angle at which the shaft can tilt from the direction of axis is φ, the angle made between the gradient of the outer surface and the direction of axis is more than φ (third structure).

Any one of the first, second, and third structures can be so constructed that the outside diameter-varying portion is formed by a separate member formed on an outer surface portion of the shaft portion (fourth structure).

In the seal portion of any one of the first through fourth structures, the inner diameter-varying portion and the outside diameter-varying portion can be made to vary in diameter at constant gradients. The outside diameter-varying portion has an inner end portion as viewed in the direction of axis. The inside diameter-varying portion has an inner end portion as viewed in the direction of axis. The former inner end portion can be located inside the latter inner end portion as viewed in the direction of axis (fifth structure).

The opening portion of any one of the first through fifth structures can be so constructed that said at least one opening portion consists of two opening portions which are formed on opposite ends of the rotating member on the axis of rotation. The shaft portion extends through the opening portions to thereby pass axially through the hollow portion (sixth structure).

In the hydrodynamic bearing of any one of the first through sixth structures, hydrodynamic pressure-producing grooves can be formed in the surface of the rotating member. When the rotating member is rotating, the hydrodynamic pressure-producing grooves convey the fluid. Thus, hydrodynamic pressure is produced.

Furthermore, in order to achieve the above-described object, the present invention provides a rotor device comprising a hydrodynamic bearing of any one of the first through sixth structures and driving means for rotationally driving the rotating member.

In addition, in order to achieve the above-described object, the present invention provides a motor comprising a hydrodynamic bearing of any one of the first through sixth structures, a rotor connected with the shaft portion of the hydrodynamic bearing, a stator-connected with the hollow member of the hydrodynamic bearing and supporting the hydrodynamic bearing and the rotor, and driving means for rotating the rotor.

### BRIEF DESCRIPTION OF THE DRAWINGS

FIG. 1 is a cross-sectional view showing a cross section of a motor according to the present embodiment, taken in the direction of axis of the motor;

FIG. 2 is a view illustrating the angular range of a shaft-side tapering portion (normal);

FIG. 2A is a view illustrating the angular range of a shaft-side tapering portion (the shaft tilts maximally);

FIG. 3 is a view illustrating the angular range of the shaft-side tapering portion (normal);

FIG. 3 is a view illustrating the angular range of the shaft-side tapering portion (the shaft tilts maximally);

FIG. 4 is a cross-sectional view showing a cross section of a motor according to a first modified example of the present embodiment, taken in the direction of axis of the motor;

FIG. 5 is a cross-sectional view showing a cross section of a motor according to a second modified example of the present embodiment, taken in the direction of the axis of the motor;

FIG. 6 is a view illustrating a seal portion according to a third modified example of the present embodiment;

FIG. 7 is a view showing one example of the structure of a motor using the prior art hydrodynamic bearing; and

FIG. 8 is a view showing the manner in which the shaft of the prior art hydrodynamic bearing has tilted.

### DETAILED DESCRIPTION OF THE PREFERRED EMBODIMENT

The preferred embodiment of the present invention is hereinafter described in detail.

(1) Summary of Embodiment

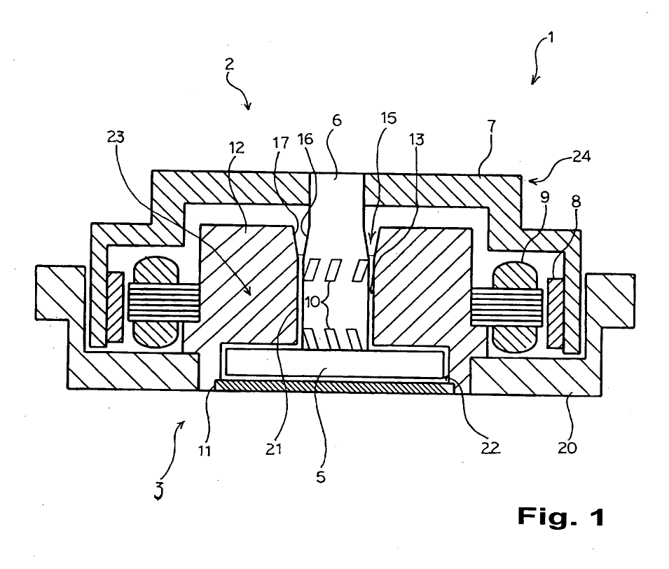

A sleeve 12 is provided with an insertion hole 21 through which a shaft 6 (FIG. 1) is passed. This hole 21 has an opening portion fitted with a seal portion 15 for suppressing leakage of oil 13 filling between a rotor 2 and a stator 3.

A sleeve-side tapering portion 17 is mounted in a portion on the side of the sleeve 12 of the seal portion 15 such that the inside diameter increases in going toward the front end of the shaft 6 (in the upward direction as viewed in the plane of FIG. 1). On the other hand, a shaft-side tapering portion 16 is formed in a portion on the side of the shaft 6 such that the outside diameter of the shaft 6 decreases.

Since the seal portion 15 is constructed in this way, surface tension produces a force that confines the oil 13 to the side of the insertion hole 21. Consequently, oil leakage can be suppressed.

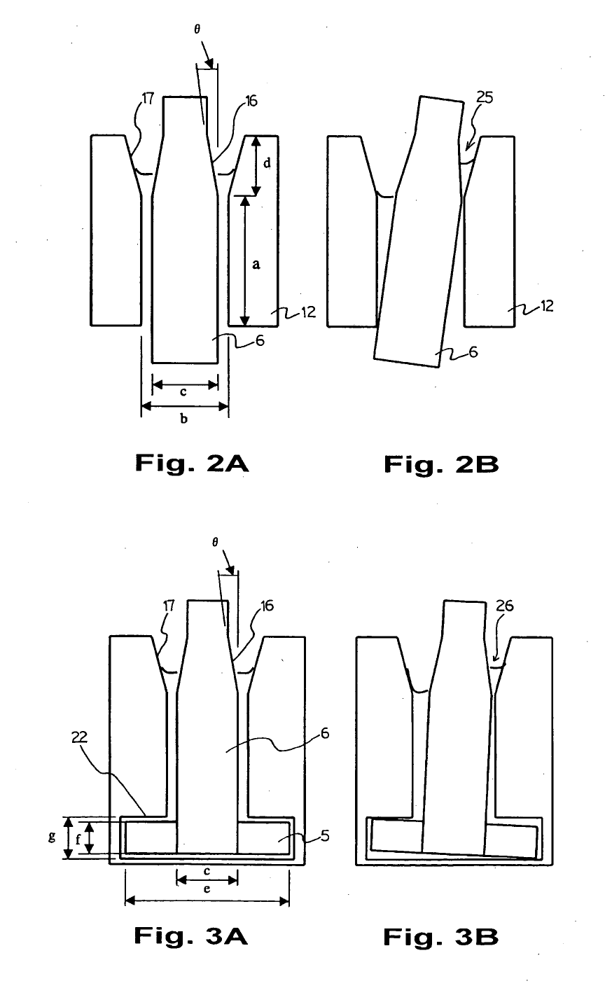

Each of the insertion hole 21 and shaft 6 has a tapering portion in this way. Therefore, if the shaft 6 tilts relative to the axis as shown in FIG. 2B, swelling of oil surface 25 in the decreased space between the sleeve 12 and shaft 6 can be prevented. Hence, oil leakage can be prevented effectively.

(2) Details of Embodiment

FIG. 1 is a cross-sectional view showing a cross section of a motor 1 according to the present embodiment, taken in the direction of axis of the motor.

The motor 1 has the rotor 2 (rotating member), the stator 3 supporting the rotor, and a hydrodynamic bearing portion 23 for rotatably holding the rotor 2 to the stator 3 by hydrodynamic pressure of the oil.

The hydrodynamic bearing portion 23 consists of a hollow portion (cavity portion), the shaft 6 received in this hollow portion, a rotating disk 5, and the oil (fluid) 13 filled in the gap portion of the hollow portion. This hollow portion is made up of the sleeve 12 and a counter plate 11.

As shown, the motor 1 is an inner rotor type motor device in which the rotor 2 is formed around the stator 3. The oil seal mechanism of the inner rotor type motor device is hereinafter described. An oil seal mechanism of an outer rotor type can be constructed similarly.

The outer dimensions of the motor 1 are as follows. The thickness taken in the direction of axis of rotation is about 3.5 mm. The length taken in a radial direction is about 2 to 3 cm. The motor 1 is an ultraminiature hydrodynamic motor for use in a 1.8-inch hard disk drive, for example.

The motor 1 rotates at a high speed of 7200 rpm, for example. In addition, high positional accuracies are required. For instance, the amount of run-out in the radial direction must be less than 0.05 mm. The amount of run-out in the direction of axis of rotation must be less than 2 mm.

Consequently, the hydrodynamic bearing structure that is a bearing structure adapted for this purpose is adopted.

Notice that no limitations are imposed on the size of the motor 1. A motor device of greater size or a smaller motor device may be constructed.

In addition, the application of the motor 1 is not limited to driving of a hard disk. For example, the motor may be used in applications where a small-sized, accurate motor device is necessary to rotate a polygon mirror in a laser printer.

First, the rotor 2 is described.

The rotor 2 is made up of the shaft 6, the hub 7 disposed at the front-end portion (top-end portion shown in FIG. 1) of the shaft 6, a permanent magnet 8 fixedly mounted to the inner surface of the hub 7, and the rotating disk 5 formed at the other-end portion (lower-end portion shown in FIG. 1) of the shaft 6.

The hub 7 is a rotating disk on which a hard disk or the like is placed. The hub 7 assumes a convex disklike form having a step portion 24. A concave space for accommodating the hydrodynamic bearing portion 23 and coils 9 is formed in the convex inside.

A through hole in which the shaft 6 is inserted is formed in the center of the hub 7 as viewed in a radial direction, and this through hole extends in the direction of axis of rotation.

The hub is fabricated by pressing or cutting stainless steel, for example.

A plurality of stages of hard disks can be installed on the outer surface of a cylindrical portion formed on the step portion 24. A head (not shown) is disposed on the surface of each of these hard disks such that the head can be moved radially by a servomechanism. Thus, data can be written and read to and from the hard disks.

The step portion 24 can be so constructed that it can be brought into agreement with a clamp-mounting hole formed in the center of a disk type storage medium such as a magnetooptical disk and placed in position. The removable storage medium can be driven.

The shaft 6 has a top-end portion that is mounted with a press fit in the through hole in the top-end portion of the hub 7. Therefore, the hub 7 and shaft 6 can rotate as a unit.

The method of mounting together the hub 7 and shaft 6 is not limited to mounting with a press fit. They may also be mounted with screw mechanisms, with adhesive, or by welding.

The permanent magnet 8 is adhesively bonded to the inner surface of a cylinder formed inside the hub 7 concentrically with the shaft 6, the cylinder forming a concave shape. The permanent magnet 8 is made of a rare-earth magnet, for example.

The permanent magnet 8 is magnetized with a given number of poles in radial directions (in the direction toward the shaft 6 and directed outside from the shaft 6). N and S poles alternately appear circumferentially on the inner surface of the permanent magnet 8 at a regular interval.

Various numbers of poles can be used. In the present embodiment, the number of poles is 12. That is, 12 poles consisting of N and S poles are formed at a regular interval circumferentially on the inner surface of the permanent magnet 8.

The permanent magnet 8 is attracted by a rotating magnetic field produced by the coils 9, producing a torque to rotationally drive the rotor 2.

The shaft 6 is a substantially cylindrical rotating shaft disposed concentrically with the axis of rotation. The shaft 6 has degrees of freedom permitting it to move in radial and thrust directions through the insertion hole 21 formed in the sleeve 12, as well as a rotational degree of freedom. Therefore, the shaft 6 is not fixed on the axis of rotation. Rather, it is normally tilted from the axis of rotation. When the rotor 2 is rotating, the shaft 6 is moving through the insertion hole 21 about the line of rotation.

The shaft 6 is scraped out of a stainless steel together with a rotating disk (described later). Thus, they are integrally machined.

The shaft 6 is made up of a front-end portion disposed outside the stator 3, an other-end portion having a larger diameter than that of the front-end portion and disposed inside the stator 3, and the shaft-side tapering portion 16 connecting the front-end and other-end portions.

The shaft-side tapering portion 16 is located in that portion of the opening portion of the insertion hole 21 formed in the sleeve 12 which is on the side of the insertion hole 21. The tapering portion 16 is so machined that the outside diameter decreases at a given gradient in going from the other-end portion toward the front-end portion.

Hydrodynamic pressure-producing grooves 10 (two stages of grooves like oblique lines tilted in different directions) for producing hydrodynamic forces in radial directions are formed in the outer surface of the other-end portion, thus forming hydrodynamic pressure-producing means. The hydrodynamic pressure-producing grooves 10 are formed by roll pressing, etching, or other method.

The disklike rotating disk 5 is formed over the whole periphery at the lower end of the other-end portion of the shaft 6.

Hydrodynamic pressure-producing grooves (not shown) such as herringbone grooves are formed in the top and bottom surfaces of the rotating disk 5 to produce hydrodynamic pressure in the thrust direction. This constitutes hydrodynamic pressure-producing means.

The rotor 2 forms a rotating member axially supported by the hydrodynamic bearing portion 23.

Next, the stator 3 is described.

The stator 3 includes the sleeve 12 accommodating the shaft 6 and so on, the coils 9 disposed on the outer surface of the sleeve 12, the counter plate 11 forming the bottom portion of the sleeve 12, and a frame 20 disposed on the outer surface of the sleeve 12 and used to fix the motor 1 to a hard disk drive or the like.

The sleeve 12 is a member constituting the portion of the hydrodynamic bearing portion 23 that is on the side of the stator. The sleeve is fabricated by scraping it out of a stainless steel, for example.

The sleeve 12 is substantially cylindrical in shape. The insertion hole 21 in which the shaft 6 is inserted is formed around a radial direction. The surface opposite to the insertion hole 21 is provided with a disk cavity portion 22 for receiving the rotating disk 5. The cavity portion 22 is formed concentrically with the insertion hole 21.

The inside diameter of the insertion hole 21 is set larger than the outside diameter of the shaft 6. A given space is formed between the inner surface of the insertion hole 21 and the outer surface of the shaft 6 such that oil 13 fills between them.

The sleeve-side tapering portion 17 is formed in the inner surface in the seal portion 15 that is opposite to the shaft-side tapering portion 16, the seal portion 15 being in the opening portion of the insertion hole 21. The inside diameter of the tapering portion 17 increases at a given gradient in going from the other-end portion of the shaft 6 to the front-end portion.

In this way, the tapers are formed respectively in the shaft 6 and insertion hole 21 in the seal portion 15 in such a way that the gap between the outer surface of the shaft 6 and the inner surface of the insertion hole 21 decreases in going toward the portion where the oil 13 is stored (i.e., in the direction directed from the front-end portion of the shaft 6 toward the other-end portion).

In consequence, a force due to capillarity that pulls the oil 13 toward the hydrodynamic bearing portion 23 and surface tension act on the surface of the oil 13 exposed to the atmosphere near the opening portion of the seal portion 15. Thus, a capillary seal that suppresses leakage of the oil 13 is formed.

Furthermore, even where the shaft 6 is tilted from the axis, the gap can be kept large in the portion where the gap between the shaft 6 and insertion hole 21 decreases in the seal portion 15, because both shaft 6 and insertion hole 21 have the tapering portions. Therefore, if the shaft 6 tilts, leakage of the oil 13 can be suppressed effectively.

A counterbore portion that is larger than the inside diameter of the disk cavity portion 22 is formed in the opening portion of the disk cavity portion 22. The counter plate 11 is mounted in this counterbore portion with a given fit tolerance. The counter plate 11 is fitted in this counterbore portion and adhesively bonded.

A disk accommodation space for accommodating the rotating disk 5 is formed by the disk cavity portion 22 and counter plate 11. The stator 3 forms a hollow member (cavity member). The disk accommodation space is analogous in shape to the rotating disk 5, and has an inside diameter set greater than the inside diameter of the rotating disk 5 and a height set greater than the thickness of the rotating disk 5.

The space formed by the insertion hole 21 and disk accommodation space forms a hollow portion that is almost analogous in shape to the member consisting of the shaft 6 and rotating disk 5. The gap of the hollow portion is filled with the oil 13.

The oil 13 causes the hydrodynamic pressure-generating grooves formed in the shaft 6 and rotating disk 5 to produce pressure. Furthermore, the oil 13 axially supports the rotor 2. In addition, the oil acts as a lubricant when the rotor 2 rotates.

The oil 13 is filled almost up to the midpoint of the seal portion 15 in the axial direction.

The plural coils 9 are circumferentially equally spaced on the outer surface of the sleeve 12. In the present embodiment, twelve coils 9 are arranged, and a stator coil of 12 poles is formed.

The magnetic poles of the coils 9 are formed radially outwardly and face the inner surface of the permanent magnet 8 with a given space therebetween.

Three-phase alternating current is supplied to the coils 9 from a power-supply system (not shown) to produce a rotating magnetic field circumferentially of the plural coils 9. This rotating magnetic field attracts the magnetic poles of the permanent magnet 8. A torque can be produced on the rotor 2.

The frame 20 is a flanged member, and its inner surface is fitted over the outer surface of the bottom portion of the sleeve 12.

A cylindrical member having a step portion swelling outward is formed at the upper end of the outer surface of the frame 20. The hub 7 is arranged concentrically on the inner surface side of the cylindrical member with a given space therebetween.

The frame 20 is held in a location where the motor 1 is installed, by mounting the step portion of the outer surface to a location where the enclosure of the hard disk drive is installed.

The operation of the motor 1 constructed as described so far is next described.

When the motor 1 is at rest, the shaft 6 and rotating disk 5 are normally held at an angle to the axis of rotation in the hydrodynamic bearing portion 23.

When three-phase current is supplied to the coils 9 and the motor 1 is started, a rotating magnetic field is first produced outside the coils 9 arranged concentrically.

The magnetic poles formed on the inner surface of the permanent magnet 8 are attracted to the rotating magnetic field. A torque that rotates the rotor 2 around the axis of rotation is produced. This torque starts rotation of the rotor 2.

When the rotor 2 rotates, the hydrodynamic pressure-producing grooves 10 formed in the other-end portion of the shaft 6 and in both end surfaces of the rotating disk 5 produce hydrodynamic pressure in the oil 13.

It is assumed that the rotor 2 rotates in a counterclockwise direction as viewed in the plane of FIG. 1. A pumping action created by the hydrodynamic pressure-producing grooves 10 produces radial hydrodynamic pressure around the other-end portion, the radial hydrodynamic pressure being directed outward from the axis of rotation.

This is due to the pumping action of the hydrodynamic pressure-producing grooves 10. It is now assumed that the shaft 6 rotates the motor 1 in a counterclockwise direction as viewed in the direction of axis of rotation in this Figure. With respect to the upper hydrodynamic pressure-producing grooves 10, the oil 13 is pumped downward. With respect to the lower hydrodynamic pressure-producing grooves 10, the oil 13 is pumped upward.

As a result, the pressure of the oil 13 is increased between the upper and lower hydrodynamic pressure-producing grooves 10. Consequently, radial pressure is produced between the other-end portion of the shaft 6 and the insertion hole 21.

The produced hydrodynamic pressure creates a radial pressure between the outer surface of the other-end portion and the inner surface of the insertion hole 21 on the side of the stator 3, the inner surface being opposite to the outer surface of the other-end portion via the oil 13. The shaft 6 is supported in the radial direction by the balance between the pressures.

With respect to the rotating disk 5, if it rotates in a counterclockwise direction as viewed in the direction of axis of rotation in the Figure, the pumping action of the hydrodynamic pressure-producing grooves formed on the both end surfaces of the rotating disk 5 produces thrust hydrodynamic pressures on both end surfaces of the rotating disk 5.

The produced hydrodynamic pressures generate a thrust pressure between the both end surfaces of the rotating disk 5 and the surfaces of the stator that are opposite to the both end surfaces of the disk 5 via the oil 13. The shaft 6 is supported in the thrust direction by the balance between the pressures produced on the both end surfaces.

The shape of the rotating disk 5 can take various forms. For example, its cross section can be a rhombus or trapezoid.

The rotor 2 is held so as to be rotatable about the axis of rotation by the balance between the radial pressure produced on the other-end portion and the thrust pressure produced on the rotating disk 5 in this way.

It is to be noted that the center axis of the shaft 6 is not always coincident with the center line of the insertion hole 21. The shaft 6 is held within the insertion hole 21 while moving somewhat and tilting.

Even where the shaft 6 rotates while tilting in this way, oil leakage can be effectively suppressed because the sleeve-side tapering portion 17 and shaft-side tapering portion 16 are formed in the seal portion 15.

Furthermore, in the present embodiment, the hydrodynamic pressure-producing grooves are formed in the rotor 2. The invention is not limited to this structure. The grooves may be formed on the side of the stator 3. Alternatively, the grooves may be formed in both rotor 2 and stator 3.

FIG. 2A is a view illustrating the angular range of the shaft-side tapering portion 16.

It is considered that in one case, the maximum value of the tilt of the shaft 6 is determined by contact of the shaft 6 with the inner wall of the insertion hole 21. In another case, the maximum value is determined by contact of the rotating disk 5 with the disk cavity portion 22.

Out of these cases, FIG. 2A illustrates the case in which the maximum angle is determined by contact of the shaft 6 with the inner wall of the insertion hole 21.

It is assumed that the insertion hole 21 has an inside diameter of b and a length of a and that the shaft 6 has an outside diameter of c as shown. The maximum value φ of the tilt of the shaft 6 is given by the following Eq. (1).

φ=cos⁻{a/(a²+b²)^{1/2}}−sin⁻¹{c/(a²+b²)^{1/2}} (1)

Let θ which is the angle that the shaft-side tapering portion 16 makes with the axis be φ. If the shaft 6 tilts maximally, the shaft-side tapering portion 16 is parallel to the axis. A sufficient gap can be kept in the seal portion 15. Accordingly, the lower limit of θ is set to φ.

It is not necessary to set the upper limit of the angle θ if θ is in excess of φ. It is appropriate, however, to set the practical upper limit to α, which is calculated based on the following concept.

The outside diameter of the front-end portion of the shaft 6 is set to one-third of c, because a center threaded hole for mounting a hard disk at the front end of the shaft 6 may be formed in some cases, and because the outside diameter of the front end of the shaft 6 can be thinned to this extent where the strength of the front-end portion is considered.

Furthermore, the length of the shaft-side tapering portion 16 taken in the direction of axis is set equal to that of the sleeve-side tapering portion 17, i.e., d.

From these conditions, the upper limit a of 0 is given by the following Eq. (2).

α=tan⁻¹{(c×⅔×½)/d} (2)

It can be seen from Eqs. (1) and (2) above that where the maximum angle of the tilt of the shaft 6 is determined by contact with the inner wall of the insertion hole 21, the angle θ of the shaft-side tapering portion 16 is set above φ and below α.

By determining the range of the angle that the shaft-side tapering portion 16 makes with the axis in this way, if the shaft 6 tilts maximally, at least a gap corresponding to the angle that the sleeve-side tapering portion 17 makes can be secured in the location where the outer surface of the shaft 6 and the inner surface of the insertion hole 21 are closest to each other in the seal portion 15. Therefore, as shown in FIG. 2B, the oil surface 25 does not swell oil leakage can be suppressed.

FIG. 3A is a view illustrating the range of the angle of the shaft-side tapering portion 16 in a case where the maximum value of the tilt of the shaft 6 is determined by contact of the rotating disk 5 with the disk cavity portion 22.

As shown in FIG. 3A, it is assumed that the disk cavity portion 22 has a height of g, the rotating disk 5 has an outside diameter of e and a height of f, and the shaft 6 has an outside diameter of c.

At this time, the maximum value φ′ of the tilt θ of the shaft 6 is given by the following Eq. (3).

φ′=sin⁻¹{g/(f²+e²)^{1/2}}−cos⁻¹{e/(f²+e²)^{1/2}} (3)

Accordingly, the lower limit of θ is set to this φ for the same reason as for Eq. (1) above. Furthermore, the upper limit of θ is set to a for the same reason as for Eq. (2) above. Because of the considerations made thus far, the angular range of the shaft-side tapering portion 16 is set above φ′ and below α in a case where the maximum value of the tilt of the shaft 6 is determined by contact of the rotating disk 5 with the disk cavity portion 22.

By setting φ in this way, if the shaft 6 tilts maximally, the oil surface 26 does not swell upward even in the location where the gap between the shaft 6 and insertion hole 21 is small as shown in FIG. 3B. Consequently, oil leakage can be suppressed.

The angle that the shaft-side tapering portion 16 makes has been described so far. The angle that the sleeve-side tapering portion 17 makes is normally set greater than 0 degree and less than 45 degrees.

The following advantages can be obtained from the present embodiment described thus far.

(1) When the shaft 6 is at rest at an angle or when the shaft 6 is rotating while tilting, the oil 13 can be stably held within the hydrodynamic bearing portion 23. Hence, oil leakage can be effectively suppressed. Therefore, the reliability of the hydrodynamic bearing portion 23 is enhanced.

(2) The seal portion 15 can form an oil reservoir that stores the oil 13.

(3) If the oil 13 expands due to variations in pressure or temperature and the inner volume of the oil 13 varies, the oil reservoir formed by the seal portion 15 prevents leakage out of the hydrodynamic bearing portion 23.

### FIRST MODIFIED EXAMPLE

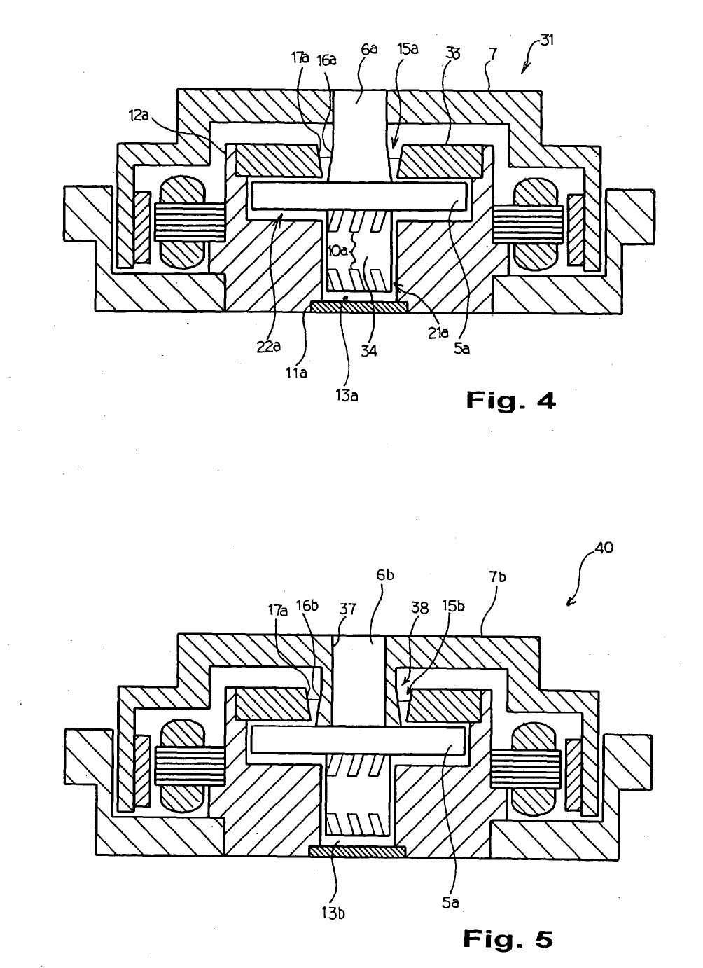

FIG. 4 is a cross-sectional view showing a cross section of a motor 31 according to a first modified example of the present embodiment, taken in the direction of axis.

The motor 31 is similar in structure to the motor 1 except that a rotating disk 5a is formed over the other-end portion 34 of the shaft 6a. Description of those portions which are identical with their respective counterparts of the motor 1 is omitted below. Those parts which are identical with their respective counterparts of the motor 1 are indicated by the same symbols. Those portions which are not identical but correspond to their respective counterparts of the motor 1 are indicated by the same symbols with alphabet “a” attached.

The shaft 6a is composed of a front-end portion inserted in the hub 7, a shaft-side tapering portion 16a forming a seal portion 15a, and the other-side portion 34. The rotating disk 5a is formed between the shaft-side tapering portion 16a and other-end portion 34.

The shaft 6a has a top-end portion inserted in a through hole formed in the hub 7.

The shaft-side tapering portion 16a is so formed that it is placed in the seal portion 15a below the top-end portion. Furthermore, the shaft-side tapering portion 16a is so formed that the outside diameter increases at a given gradient in going toward the other-end portion 34.

The rotating disk 5a for producing thrust hydrodynamic pressure is mounted on the shaft 6a under the shaft-side tapering portion 16a.

Hydrodynamic pressure-producing grooves (not shown) such as herringbone grooves for producing thrust hydrodynamic pressures are formed in the both end surfaces of the rotating disk 5a.

The other-end portion 34 for producing radial hydrodynamic pressure is formed below the rotating disk 5a.

Hydrodynamic pressure-producing grooves 10a (two stages of grooves like oblique lines tilted in different directions relative to the direction of axis) for producing radial hydrodynamic pressures are formed in the outer surface of the other-end portion 34 of the shaft 6a.

As described so far, in the present modified example, the rotating disk 5a is formed between the top-end portion of the shaft 6a and other-end portion 34.

A sleeve 12a is substantially cylindrical in shape and has a disk cavity portion 22a and an insertion hole 21a around a radial direction. The rotating disk 5a is received in the disk cavity portion 22a. The shaft 6 is inserted in the insertion hole 21a.

A counterbore portion in which an upper plate 33 is mounted with a fit tolerance is formed in the top end of the disk cavity portion 22a. When the upper plate 33 is mounted in this counterbore portion, a space substantially analogous to the rotating disk 5a and used to accommodate it is formed.

The inside diameter of the insertion hole 21a is set greater than the outside diameter of the other-end portion 34 of the shaft 6a. A given space is formed between the inner surface of the insertion hole 21a and the outer surface of the other-end portion 34 to fill this space with oil 13a.

A counterbore portion in which the counter plate Ha is mounted with a fit tolerance is formed in the bottom of the insertion hole 21a.

An oil reservoir for storing the oil 13a is formed under the other-end portion 34 by mounting the counter plate 11a in this counterbore portion.

The upper plate 33 is a cylindrical member and provided with a through hole in which the shaft 6a is inserted, the hole being located in the center in a radial direction.

The inside diameter of this through hole increases at a given gradient toward the front-end portion of the shaft 6a. Thus, a sleeve-side tapering portion 17a is formed.

The shaft-side tapering portion 16a and sleeve-side tapering portion 17a formed in the shaft 6a are located opposite to each other. These tapering portions 16a, 17a, and the space via which they are opposite to each other form the seal portion 15a.

The oil 13a is filled in the sleeve 12a almost up to the midpoint of the seal portion 15a in the axial direction.

Leakage of the oil 13a can be effectively suppressed, in the same way as in the embodiment described previously, by forming the seal portion 15a in this way.

### SECOND MODIFIED EXAMPLE

FIG. 5 is a cross-sectional view showing a cross section of a motor 40 according to a second modified example of the present embodiment, taken in the direction of the axis.

The motor 40 is similar in structure with the motor 31 except that a shaft-side tapering portion 16b is formed integrally with a hub 7b. Description of those portions which are identical with their respective counterparts of the motor 31 is omitted below. Those portions which are identical with their respective counterparts of the motor 31 are indicated by the same symbols. Those portions which are not identical but correspond to their respective counterparts are indicated by the same symbols with alphabet “b” attached.

The hub 7b has a substantially cylindrical protruding portion 38 in a central portion in a radial direction. The protruding portion 38 extends to the other-end portion of the shaft 6a (i.e., in the downward direction as viewed in the Figure).

A through hole 37 having a cylindrical inner surface for insertion of the shaft 6b is formed in the center of the protruding portion 38 in a radial direction.

And, the shaft 6b is inserted into the through hole 37 until the lower end surface of the protruding portion 38 strikes the upper end surface of the rotating disk 5a.

The shaft-side tapering portion 16b is formed on the outer surface of the protruding portion 38 such that the outside diameter of the protruding portion 38 increases at a given gradient in going toward the rotating disk 5a.

The positional relation of the shaft-side tapering portion 16b to the sleeve-side tapering portion 17b is such that the tapering portion 16b faces the tapering portion 17b. The shaft-side tapering portion 16b, the sleeve tapering portion 17b, and the space via which they face each other form a seal portion 15b.

The shaft 6b has a cylindrical upper-end portion. The outside diameter of this upper-end portion is so set that it can be inserted into the through hole 37 with a given fit tolerance.

The upper-end portion of the shaft 6b is firmly mounted in the hub 7b with a press fit, for example. The shaft 6b and hub 7b rotate as a unit.

The oil 13b is filled in the seal portion 15b almost up to the midpoint in the direction of axis of rotation.

In the second modified example described so far, it is not necessary to form any tapering portion in the shaft 6b. This facilitates machining the shaft 6b.

### THIRD MODIFIED EXAMPLE

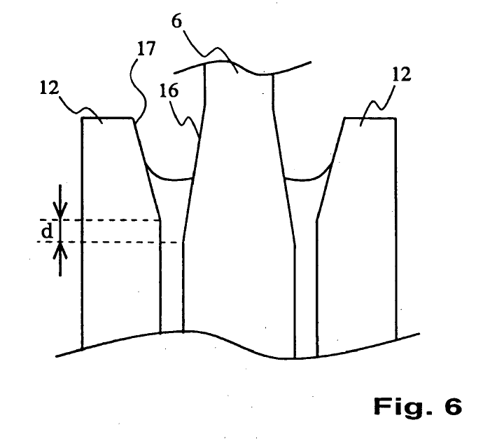

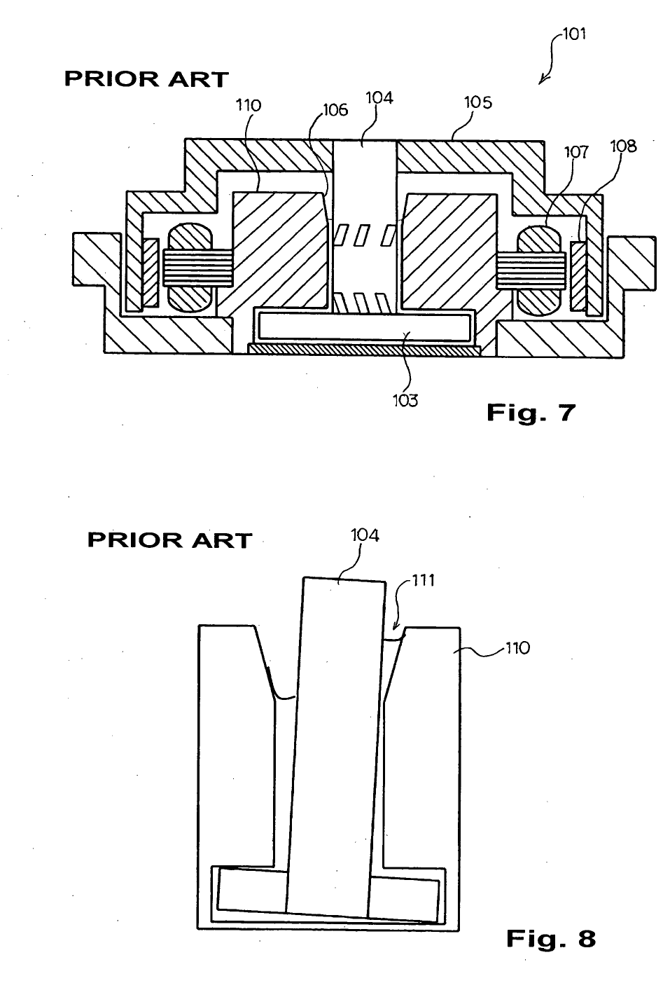

In the present modified example, the lower-end portion of the shaft-side tapering portion 16 is placed under (on the side of the lower-end portion of the shaft 6) the lower-end portion of the sleeve-side tapering portion 17 in the seal portion 15 according to the present embodiment, as shown in FIG. 6.

In FIG. 6, the lower-end portion of the shaft-side tapering portion 16 is formed lower than the lower-end portion of the sleeve-side tapering portion 17 by d.

Where the lower-end portion of the sleeve-side tapering portion 17 is set lower (as viewed in the Figure) than the lower-end portion of the shaft-side tapering portion 16, the action of the surface tension of the oil 13 intensifies the force that pulls the oil 13 toward the location where the oil 13 stays, thus enhancing the ability to suppress leakage of the oil 13.

Therefore, the length of the sleeve-side tapering portion 17 taken in the direction of axis of rotation can be shortened. Consequently, the length of the motor 1 taken in the direction of axis can be reduced.

It is an important subject for motors used in hard disks or the like to achieve miniaturization. The present modified example contributes to meeting this subject.

While the present embodiment and its first, second, third modified examples have been described so far, the present invention is not limited thereto. Rather, various changes and modifications are possible within the scope set forth by the claims.

For example, in the embodiment described above, the seal portion 15 is constructed using the shaft-side tapering portion 16 and sleeve-side tapering portion 17. This does not mean that the shaft-side tapering portion 16 and sleeve-side tapering portion 17 are limited to tapering form. Various shapes can be adopted as long as the gap between the shaft 6 and insertion hole 21 increases in going toward the front end of the shaft 6.

For instance, at least one of them may be R-shaped or formed by an arbitrary curved surface different from taper form and R shape.

The present embodiment and its modified examples have been described in relation to a hydrodynamic bearing having a bag on one side. The invention is not limited to this structure. The seal portion according to the invention can be used for a hydrodynamic bearing that is open on both sides.

The “hydrodynamic bearing having a bag on one side” has an opening at one end of the hollow portion of a hydrodynamic bearing portion. A shaft axially extends through this opening portion. The “hydrodynamic bearing that is open on both sides” has two opening portions on the axis of rotation in the hollow portion. A shaft axially extends through the two opening portions and thus the shaft extends through the hollow portion.

The present invention can offer a hydrodynamic bearing fitted with a seal portion capable of suppressing leakage of fluid effectively. The invention can also offer a rotor device and a motor using this hydrodynamic bearing.

What is claimed is:

1. A hydrodynamic bearing comprising:
a hollow member having a hollow portion provided with at least one opening portion at least one end thereof;
a rotating member disposed in said hollow portion so as to be rotatable relative to said hollow member and having a shaft portion extending through said opening portion;
fluid interposed between said hollow portion and said rotating member;
hydrodynamic pressure-producing means acting on said fluid between mutually opposite surfaces of said hollow member and said rotating member and producing hydrodynamic pressure with said opposite surfaces; and
a seal portion for preventing leakage of said fluid from said opening portion;
wherein said seal portion is formed by an inner diameter-varying portion and an outside diameter-varying portion, said inner diameter-varying portion being so formed that the inside diameter of said opening portion increases in going outwardly in an axial direction of said shaft portion, said outside diameter-varying portion being so formed that at least a part of the outside diameter of said shaft portion opposite to said inner diameter-varying portion decreases in going outwardly in said axial direction.

2. The hydrodynamic bearing of claim 1, wherein at least one of the inside diameter of said opening portion and the outside diameter of said shaft portion varies in diameter at a constant gradient in said seal portion.

3. The hydrodynamic bearing of claim 1, wherein the outside diameter of said shaft portion varies at a constant gradient in said seal portion, and wherein an angle made between the gradient of said outer surface and said axial direction is more than f, which is a maximum angle at which said shaft portion can tilt from said axial direction.

4. The hydrodynamic bearing of claim 1, wherein said outside diameter-varying portion is formed by a separate member formed on the outer surface of said shaft portion.

5. The hydrodynamic bearing of claim 1, wherein said inside diameter-varying portion and said outside diameter-varying portion vary in diameter at constant gradients in said seal portion, and wherein an end portion of said outside diameter-varying portion that is located inside in said axial direction is formed inside of an end portion of said inside diameter-varying portion that is located inside in said axial direction, as viewed in said axial direction.

6. The hydrodynamic bearing of claim 1, wherein said at least one opening portion consists of two opening portions formed at two opposite ends, respectively, on the axis of rotation of said rotating member in said hollow member, and wherein said shaft portion extends through said opening portions and thus extends axially through said hollow portion.

7. A rotor device comprising:
a hydrodynamic bearing set forth of claim 1; and
driving means for rotationally driving said rotating member.

8. A motor comprising:
a hydrodynamic bearing set forth of claim 1;
a rotor connected to the shaft portion of said hydrodynamic bearing;
a stator connected to the hollow member of said hydrodynamic bearing and supporting said hydrodynamic bearing and said rotor; and
driving means for rotating said rotor.
